(19) United States
(12) Patent Application Publication
(10) Pub. No.: US 2022/0154674 A1
(43) Pub. Date: May 19, 2022

(54) NOZZLE FOR A FUEL INJECTOR

(71) Applicant: LIEBHERR-COMPONENTS DEGGENDORF GMBH, Deggendorf (DE)

(72) Inventors: Klaus LICHTINGER, Geiselhoering (DE); Thomas ATZKERN, Augsburg (DE); Markus HOELLBACHER, Oberalm (AT); Michael SCHMID, Bischofsmais (DE)

(21) Appl. No.: 17/430,698

(22) PCT Filed: Feb. 10, 2020
(86) PCT No.: PCT/EP2020/053263

§ 371 Date: Aug. 12, 2021

(30) Foreign Application Priority Data
Feb. 12, 2019 (DE) 10 2019 103 511.2

(51) Int. Cl. F02M 61/18; F02M 61/10

(52) U.S. Cl. CPC F02M 61/188; F02M 61/10; F02M 2200/46; F02M 2200/04; F02M 61/182

(57) ABSTRACT

The present disclosure relates to a nozzle for a fuel injector that comprises a pivotably symmetrical nozzle member having a hollow space for introducing a nozzle needle, a nozzle tip that is provided at a longitudinal end of the nozzle member, and at least one opening for discharging fuel, and a nozzle needle arranged in the hollow space for a selective blocking of a fuel inflow to the at least one opening, wherein the nozzle needle is designed as tubular in the region of the nozzle tip and is adapted to conduct fuel in the interior of the tubular region to the at least one opening.

### TECHNICAL FIELD

The present disclosure relates to a nozzle for a fuel injector and to a fuel injector having such a nozzle. Fuel injectors, that are also called injection nozzles, are an essential component of every internal combustion engine since the required quantity of the fuel to be combusted is introduced into the combustion chamber via them. It is of great importance for a clean combustion here to maintain an opening and closing of the injector that is as fast as possible over the total service life of an injector to be able to continuously supply an exact quantity of a fuel.

### BACKGROUND AND SUMMARY

Nozzles for fuel injectors are currently typically known whose openings for discharging highly pressurized fuel start from a so-called blind hole. The blind hole is a space that is arranged below the nozzle needle movable in the longitudinal direction and that is fluidically separable from a reservoir for highly pressurized fuel by the placing of the nozzle needle onto a seat region (cf. FIG. 3). If the nozzle needle is raised from the seat region of the nozzle member, fuel flows into the blind hole and from there via the openings out of the nozzle. The nozzle needle is here flowed around by fuel from the outside that flows in the direction of the openings.

It is now the aim of the present disclosure to improve the already known nozzles for fuel injectors or the fuel injectors themselves to achieve one or more of the following points such as optimization of the fuel flow (or the cavitation behavior), a weight reduction, a reduction of the harmful volume, an improvement of the hydraulic efficiency, an increase of the throughflow, a shortening of the injection hole length, an increase of the pressure resistance, a faster dethrottling, and an improved engine behavior (emission, consumption, . . . ).

This is done using a nozzle for a fuel injector that has all the features described in the embodiment. The nozzle accordingly comprises a pivotably symmetrical nozzle member having a hollow space for introducing a nozzle needle, a nozzle tip that is provided at a longitudinal end of the nozzle member, and at least one opening for discharging fuel, and a nozzle needle arranged in a hollow space for a selective blocking of a fuel inflow to the at least one opening, wherein the nozzle needle is designed as tubular in the region of the nozzle tip and is adapted to conduct fuel in the interior of the tubular region to the at least one opening.

Provision can be made here that the nozzle needle is a tubular needle nozzle or a hollow needle whose interior is adapted to conduct fuel.

Provision can furthermore be made that the outer periphery of the nozzle needle is constant in its third facing the nozzle tip, or in its half facing the nozzle tip. The outer periphery of the nozzle needle is accordingly constant along its longitudinal direction in its half or third facing toward the tip. This significantly simplifies the manufacture of the nozzle member.

This design is of advantage in combination with the rounded front sides of the tubular region of the nozzle needle.

In some embodiments, the rounded edges can have the shape of a quarter circle in cross-section whose center is arranged at the outer periphery of the nozzle needle.

The pressure losses between the rail and the (no longer present) blind hole are reduced since the fuel flow in the nozzle no longer flows around the nozzle needle, but can be conducted through the tubular section of the nozzle needle itself so that the injector can be operated at a lower pressure to deliver the same performance. This in turn results in savings in the drive performance of the pump and in configuration advantages (wall thickness, material, etc.).

The blind hole that is decisively responsible for the HC emissions (hydrocarbon emissions) is additionally no longer necessary due to the nozzle in accordance with the disclosure. The design in accordance with the disclosure therefore achieves considerable improvements with respect to the emissions, with respect to the HC emissions, and has the consequence of a smaller consumption and a longer durability (due to less cavitation damage and an improved volume stability).

A fluidic connection from the at least one opening to a reservoir for the reception of pressurized fuel may only run through the tubular region of the nozzle needle. The inflow of fuel toward the at least one opening therefore takes place through the tubular section that can then also be embodied by a bore. The fuel accordingly no longer flows around the nozzle needle, but rather flows in the nozzle needle in the direction of the fuel openings.

Provision is made in accordance with modification of the disclosure that the nozzle needle interrupts a fluidic connection of the at least one opening to a reservoir for receiving pressurized fuel by the placing onto a seat surface of the nozzle member.

Provision can be made in this respect that the nozzle needle has a front-side discharge opening that is closable by placing onto a seat surface of the nozzle member or of the nozzle tip at its end facing the nozzle tip. This discharge opening can be formed in one piece with the tubular section of the nozzle needle so that a fuel flowing through the nozzle needle is discharged from the nozzle needle at the front side.

Provision can be made in accordance with a further development of the disclosure that the nozzle tip has a conical elevated portion, such as in the form of a right circular cone whose tip penetrates into the interior of the tubular region of the nozzle needle in a closed state of the nozzle, toward the hollow space for the nozzle needle in a cross-section. Provision can be made alternatively to this that the nozzle tip has a planar surface on the side facing the nozzle needle or even a converging structure, for example a tapering structure.

The conical elevated portion brings about the advantage that exiting fuel only has to be deflected once, namely at the conical elevated portion, from where it can be discharged via the at least one opening without a further deflection.

It was necessary in accordance with the prior art that the fuel flowing around the nozzle needle is deflected a first time on the flowing into the blind hole and a second time on the entry into the at least one discharge opening so that the occurrence of cavitation damage is very much more likely in the prior art.

Provision can furthermore be made here that the at least one opening for the discharge of fuel is adjacent to the jacket surface of the conical elevated portion, such that a fuel from the tubular region of the nozzle needle can flow out of the at least one opening in a straight line by a single deflection at the conical elevated portion in a state of the nozzle needle raised from the conical elevated portion. Provision can therefore be made that a longitudinal inner margin of the at least one opening passage is aligned with the jacket surface so that fuel can be smoothly guided from the jacket surface into the opening.

Provision can also be made here that the conical elevated portion and the nozzle needle are arranged coaxially to one another. This has the result that—in a closed state of the nozzle—the tip of the conical elevated portion penetrates into the tubular section. If the front-side end sections of the tubular region now contact the conical elevated portion, a closing of the nozzle takes place. Fuel can no longer flow out of the interior of the nozzle needle in the direction of the at least one discharge opening.

In accordance with a modification of the disclosure, a region of the jacket surface of the conical elevated portion that surrounds the tip of the conical elevated portion represents a seat region for the nozzle needle that is contacted by the nozzle needle in a closed state of the nozzle.

The nozzle needle has rounded edges in its end section facing the nozzle tip. The surface that contacts the conical elevated portion is thereby minimized so that a sufficient sealing for the interruption of a fuel flow is present at an already relatively small force.

The at least one opening for the discharge of fuel may furthermore not be connected to a blind hole. As already discussed above, it is not necessary in accordance with the disclosure that a blind hole arranged beneath the nozzle needle is present. The at least one opening for outputting fuel now starts directly from the seat region and is aligned with the jacket surface of the conical elevated portion.

The opening channel of the least one opening for discharging fuel is directly directed to the seat region of the nozzle needle and/or directly starts from the seat region.

Provision can furthermore be made that the tubular region of the nozzle needle extends up to its tip so that the nozzle needle has a tubular outlet there.

The variant is likewise covered by the disclosure that the tubular region of the nozzle needle is pivotally symmetrical and the region of the nozzle needle facing the nozzle tip can be rotationally symmetrical.

Provision can furthermore be made that the outer periphery of the nozzle needle is constant in its half facing the nozzle tip, or in its third facing the nozzle tip. A simple design of the nozzle member is thereby possible. Only a few bores are then required for this purpose.

The disclosure further relates to a fuel injector having a nozzle in accordance with one of the preceding claims.

The fuel injector may be provided with a reservoir for receiving pressurized fuel, with a fluidic connection of the at least one reservoir to the at least one opening for discharging fuel only extending through the interior of the tubular region of the nozzle needle. In an embodiment, this can take place when the nozzle needle is raised from its state interrupting a fuel flow in which the front sides of the nozzle needle no longer contacts the associated seat surface of the nozzle tip.

The disclosure also relates to an engine having a nozzle in accordance with one of the variants described above or to a fuel injector as described above.

### BRIEF DESCRIPTION OF THE FIGURES

Further features, details of the disclosure will become clear with reference to the following description of the Figures. There are shown:

FIG. 1: a schematic view of a nozzle in accordance with the disclosure in a partially shown fuel injector;

FIG. 2: a schematic view of the distal end region of the nozzle in accordance with the disclosure; and

FIG. 3: a halved sectional view through a front region of a fuel nozzle in accordance with the prior art.

### DETAILED DESCRIPTION

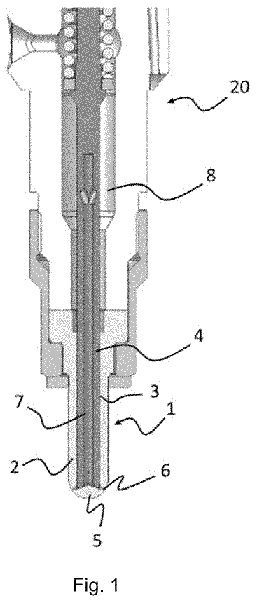

FIG. 1 shows a schematic view of a nozzle 1 in accordance with the disclosure in a partially shown fuel injector 20. The nozzle member 2 can be recognized here that has a nozzle tip 5 at its distal end that has a plurality of openings 6 for discharging fuel. The nozzle member 2 here has a hollow space 3 for receiving a nozzle needle 4 that is movably received therein. The nozzle needle 4 can be moved along its longitudinal axes in accordance with the known principles for the raising and lowering of a nozzle needle 4 that are not restrictive for the present disclosure.

It can likewise be recognized that the nozzle needle 4 has a tubular region 7 that is adapted to conduct fuel from a proximal region of the nozzle 1 to a distal region (that is toward the tip) of the nozzle 1. The nozzle needle 3 can here be formed as a tubular needle nozzle. It is also conceivable that the tubular region 7 is formed by a bore that extends coaxially to the longitudinal direction of the nozzle needle 4.

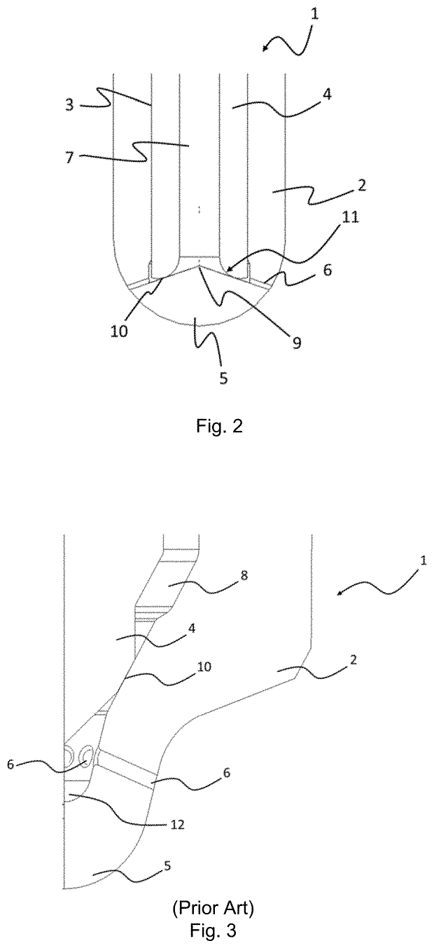

FIG. 2 represents an enlarged view of an end region of the nozzle 1 in accordance with the disclosure.

It can be recognized that the nozzle tip 5 of the nozzle member 2 has a conical elevated portion 9 at the side facing the tubular region 7 of the nozzle need 4, the tip of said conical elevated portion 9 projecting into the interior of the tubular region 7.

In a closed state of the nozzle 1, the front surfaces of the nozzle needle 4 contact the conical elevated portion 9 at the so-called seat surface 10 and seal the interior of the nozzle needle 4 with respect to the at least one discharge opening 6. The front sides of the nozzle needle 4 are rounded here (cf. reference numeral 11) so that a small contact surface with the conical elevated portion 9 already achieves the desired sealing. It is additionally thereby possible to achieve a sealing in a reliable manner despite production tolerances.

If the nozzle needle 4 is raised from the seat surface 10, highly pressurized fuel can exit the nozzle 1 through the openings 6. In this process, the fuel is only deflected once, namely on the impact with the elevated portion 9, so that a little to absolutely no cavitation damage occurs.

FIG. 3 shows a nozzle 1 in its region of the tip in accordance with the prior art. The nozzle member 2 has a cutout 8 into which a nozzle needle 4 is introduced. This nozzle needle 4 is—unlike in accordance with the disclosure—designed as solid and contacts an inner section of the nozzle member 2 in the region of the seat surface 10 in a peripheral region.

A blind hole 12 from which the openings 6 start for the exiting of fuel from the nozzle 1 is provided beneath the seat surface 10. A multiple deflection of fuel is necessary due to this design, which promotes the occurrence of cavitation damage.

Provision is additionally made in accordance with the prior art that the fuel flowing out through the openings 6 flows around the solid nozzle needle 4.

1. A for a fuel injector comprising:
a pivotably symmetrical nozzle member having a hollow space for introducing a nozzle needle;
a nozzle tip that is provided at a longitudinal end of the nozzle member and has at least one opening for discharging fuel: and
a nozzle needle arranged in the hollow space for selective blocking of a fuel supply to the at least one opening,
wherein
the nozzle needle is designed as tubular in a region of the nozzle tip and is adapted to conduct fuel in an interior of a tubular region toward the at least one opening.

2. The nozzle in accordance with claim 1, wherein a fluidic connection from the at least one opening to a reservoir for reception of pressurized fuel only runs through the tubular region of the nozzle needle.

3. The nozzle in accordance with claim 1, wherein the nozzle needle interrupts a fluidic connection of the at least one opening to a reservoir for receiving pressurized fuel by placing onto a seat surface of the nozzle member.

4. The nozzle in accordance with claim 1, wherein the nozzle tip has a conical elevated portion toward the hollow space for the nozzle needle, in the form of a right circular cone whose tip penetrates into the interior of the tubular region of the nozzle needle in a closed state of the nozzle.

5. The nozzle in accordance with claim 4, wherein the at least one opening for the discharge of fuel is adjacent to a jacket surface of the conical elevated portion, such that a fuel from the tubular region of the nozzle needle can flow out of the at least one opening in a straight line by a single deflection at the conical elevated portion in a state of the nozzle needle raised from the conical elevated portion.

6. The nozzle in accordance with claim 4, wherein the conical elevated portion and the nozzle needle are arranged coaxially to one another.

7. The nozzle in accordance with claim 5, wherein a region of the jacket surface of the conical elevated portion that surrounds the tip of the conical elevated portion represents a seat region for the nozzle needle that is contacted by the nozzle needle in a closed state of the nozzle.

8. The nozzle in accordance with claim 3, wherein the nozzle needle has rounded edges in its end section facing the nozzle tip.

9. The nozzle in accordance with claim 1, wherein the at least one opening for discharging fuel is not connected to a blind hole.

10. The nozzle in accordance with claim 7, wherein the at least one opening for discharging fuel is directly directed with its opening channel onto the seat region of the nozzle needle and/or starts directly from the seat region.

11. The nozzle in accordance with claim 1, wherein the tubular region of the nozzle needle extends up to its distal tip so that the nozzle needle has a tubular outlet there.

12. The nozzle in accordance with claim 1, wherein the tubular region of the nozzle needle is pivotally symmetrical.

13. The nozzle in accordance with claim 1, wherein an outer periphery of the nozzle needle is constant in its third facing the nozzle tip.

14. The fuel injector having a nozzle in accordance with claim 1.

15. The fuel injector in accordance with claim 14, further comprising a reservoir for receiving pressurized fuel, with a fluidic connection of the reservoir to the at least one opening for discharging fuel only extending through the interior of the tubular region of the nozzle needle.

16. The nozzle needle in accordance with claim 8, wherein the end section facing the nozzle tip-contacts the seat surface with the rounded edges.

17. The nozzle needle in accordance with claim 12, wherein the region of the nozzle needle facing the nozzle tip is rotationally symmetrical.
